(19) United States
(12) Patent Application Publication
(10) Pub. No.: US 2008/0262963 A1
(43) Pub. Date: Oct. 23, 2008

(54) System and method for developing innovations through establishment of corporate entities

(75) Inventors: Neil Loxley, Hamsterley (GB); Sean Warren, Scorton (GB); Chris Thompson, Newcastle-upon-Tyne (GB); Klaus Schnurr, York (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Product Futures Limited, Durham (GB)

(21) Appl. No.: 11/788,228

(22) Filed: Apr. 19, 2007

(51) Int. Cl. G06Q 10/00; G06Q 30/00; G06Q 90/00

(52) U.S. Cl. 705/39; 705/1

(57) ABSTRACT

A method of developing a product idea through establishment of a corporate entity is disclosed. The method comprises screening one or more new product ideas against a number of predetermined criteria to identify a filtered product idea which meets the predetermined criteria, establishing a portfolio corporate entity having share capital, assigning intellectual property rights in the filtered product idea to the portfolio corporate entity, and controlling the portfolio corporate entity while the filtered product idea is subject to product development.

### FIELD OF THE INVENTION

The present invention relates to a method of sourcing and developing innovative products, and in particular to a method of developing product ideas through establishment of a corporate entity.

### BACKGROUND OF THE INVENTION

A major problem impeding innovation is often the lack of an established process for developing and marketing innovations. Large companies have long implemented their own internal systems for developing, protecting, and marketing innovations, but these can be unwieldy and do not always result in successful products. Smaller companies and individuals often have good ideas but lack the skills and experience to convert these ideas into successful products. Individual inventors or product designers may be intimidated by the development process, and may have to assign all rights in their inventions to large companies who then develop and market the ideas, leaving the originator of the product idea without any stake in the process.

With the advent of the Internet, several Internet web sites have attempted to provide a marketplace for intellectual property. These sites, however, focus on intellectual property that has already been protected such as existing patented technology or the like. One disadvantage of these sites is that smaller companies and individuals must seek protection for their innovations prior to seeking a market for those innovations. This may lead to unnecessary expense if the innovator is unable to find a market for their innovation. U.S. Patent Publication No. U.S. 2002-0016727 A1 proposes a method for implementing an innovation marketplace that enables innovators to further develop and market innovations without necessitating that the innovator first seek protection of their rights. The marketplace enables developers to access the system to search for innovations suited to their development needs and capabilities. However the method still relies on the innovators skills in product development and does not guarantee that the inventor will have a stake in any business which successfully exploits the innovation.

The present invention sets out to solve at least some of the above-identified problems. There is a growing trend amongst larger companies to source product innovation from outside their organisation—this is referred to as open innovation. Open innovation was developed to try to improve on the current situation whereby the large amounts of money spent on research and development result in relatively few products being released to market. In some industries the open innovation model is more familiar than in others. For example open innovation has been embraced in semiconductor development and manufacturing, but is not common in many consumer industries, for example household consumable products.

The present inventors have developed a business model that facilitates this open innovation process for all parties involved in the design and bringing to market of new products. These include the brand owners, a term used to describe companies who market products to end purchasers, and who may manufacture their products or source their products from third party suppliers. Often the brand owners will have in-house research and development facilities who bring forward new products. The brand owners will generally own a number of recognisable brands known to the end purchasers or consumers, but the term brand owner is used to include all companies selling products, even if they licence the brands from third parties or sell their products under the brand names of other parties.

The business model also facilitates the open innovation process for investors, for organisations involved in design and development, and for product concept originators, be they other brand owners, design agencies, individual contributors or entrepreneurs, or even insolvency practitioners, who may find themselves owning rights to product designs which they find themselves unable to exploit.

### SUMMARY OF THE INVENTION

According to one embodiment of the present invention there is provided a method of developing a product idea through establishment of a corporate entity, the method comprising:

screening one or more new product ideas against a number of predetermined criteria to identify a filtered product idea which meets the predetermined criteria,

establishing a portfolio corporate entity having share capital,

assigning intellectual property rights in the filtered product idea to the portfolio corporate entity,

controlling the portfolio corporate entity while the filtered product idea is subject to product development.

A commercialisation company may carry out the method as a business activity. The commercialisation company may solicit new product ideas by any suitable means, such as through advertising or personal contact. The criteria may include criteria relating to patentability, freedom-to-use searches, nature of competing products, cost of manufacture, potential profit, health and safety issues, size of market, type of market, requirements of known potential investors, due diligence in relation to ownership of intellectual property rights and any other suitable criteria as defined by the commercialisation company.

The method may further include purchasing share capital in the portfolio corporate entity sufficient to take a controlling interest in the portfolio corporate entity.

The commercialisation company may thus become a major shareholder in the newly established portfolio corporate entity, and may invest some or all of the funds necessary for establishment. External investors may also invest funds.

The assigning step may comprise purchasing the intellectual property rights from a product originator in return for a consideration comprising a share in the value of the portfolio corporate entity. The product originator, or owner of the intellectual property rights in the filtered product idea, may assign his rights to the newly established portfolio corporate entity in return for a shareholding or stake in the portfolio company. This shareholding may be a non-diluting shareholding. The commercialisation company may hold a controlling interest in the portfolio corporate entity while the filtered product idea is subject to product development, and thus may use its knowledge and expertise to guide the product development. The shareholding held by the product originator may be in the form of shares with no voting rights. The shareholding held by the commercialisation company may be in the form of shares with voting rights.

The method may further include bringing the filtered product idea to market. In this scenario the commercialisation company may continue to hold a controlling interest in the portfolio corporate entity while the filtered product idea is brought to market, and will thus benefit with other shareholders in successful commercialisation of the product.

The method may further include granting rights in the filtered product idea to a brand owner. The brand owner may be any organisation interested in exploiting the product idea.

The method may further include carrying out one or more product development tasks in relation to the filtered product idea. These tasks may be carried out by the portfolio company under the direction of the commercialisation company. Alternatively the method may further include granting a licence to the brand holder to carry out one or more product development tasks in relation to the filtered product idea. This may be done where the brand holder has specific skills and expertise in developing products of the type of the filtered product idea.

The product development tasks may include at least one of developing a product design based on the filtered product idea, market testing of the product design, consumer validation of the product design and pilot manufacture of the product design.

The method may further include selling at least a portion of the share capital of the portfolio corporate entity to the brand owner. The brand owner may purchase all of the share capital, such that the commercialising company realises a return on its investment and the innovator realises a return on his intellectual property rights. The purchase may include the payment of a licence fee to the innovator, and this may continue after the purchase.

The method may further include licensing intellectual property rights in the filtered product idea from the portfolio corporate entity to the brand owner.

The product originator may be the first owner of the intellectual property rights in the filtered product idea, such as the inventor or the employer of the inventor, or may acquire the intellectual property rights in the filtered product idea from a first owner of the intellectual property rights in the filtered product idea. For example, an insolvency practitioner may acquire intellectual property rights through the winding up of a company, or a company may have commissioned a design project in which it has no further interest.

The method may include the further step of identifying a strategic brief from the brand owner and including criteria derived from the strategic brief in the predetermined criteria. The commercialising company may be commissioned by the brand owner to find product ideas meeting certain requirements of the brand owner, for example being directed to a particular market or meeting a need in a particular area of activity.

The method may include after the screening step the further steps of presenting a filtered product idea to the brand owner and offering an exclusive licence under the screened product to the brand owner.

The method may include the further step of receiving a licensing fee from the brand owner during the carrying out one or more product development tasks in relation to the filtered product idea.

Other features and advantages of the present invention will become apparent to one skilled in the art upon examination of the following drawings and detailed description. It is intended that all such features and advantages be included herein within the scope of the present invention.

### BRIEF DESCRIPTION OF THE DRAWINGS

FIG. 1 is a schematic illustration of a method of developing a product idea through establishment of a corporate entity according to one possible embodiment of the invention.

FIG. 2 is a flow-chart illustrating a possible procedure whereby a brand owner is given options to exploit a product idea developed according to one aspect of the present invention.

FIG. 3 is a schematic illustration of the share ownership over time of a portfolio corporate entity according to another aspect of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is generally directed to a method of sourcing new product concepts and screening them against a number of criteria, before assigning the intellectual property of each successfully screened idea to a respective portfolio company that is incorporated specifically to develop the concept into a marketable product. The operator of the method, which may be a commercialisation company, will then source funding, develop the product, assess and test the market and aim to prove market acceptance by achieving early sales. With a typical consumer product this might involve achieving sales of 10,000 units or more. Once this market acceptance has been demonstrated, or at earlier stage in the product development process in the case of strong positive consumer testing and customer research at a prototype stage, then the commercialisation company will identify potential exit partners and aim to (a) dispose of the portfolio company, and thereby the intellectual property rights associated with the product, product IP; (b) keep their holding in the portfolio company and generate income for the portfolio company by licensing the intellectual property rights associated with the product; or (c) keep their holding in the portfolio company and run the portfolio company as a trading company, trading in manufacture and sales of the product.

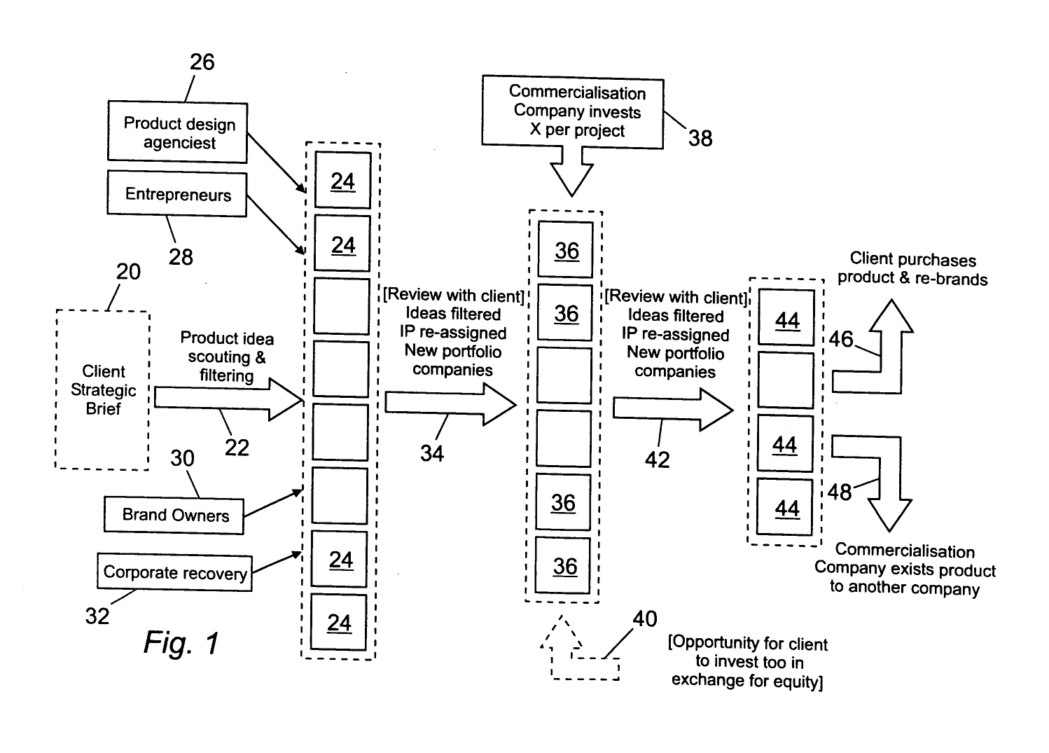

FIG. 1 is a schematic illustration of one example of the method of the invention. The method may be carried out by any person or legal entity. In the present example the method is assumed to be carried out by a commercialisation company.

As shown in process block 22, at the outset of the process the commercialisation company then scouts among a number of new product ideas to identify and filter product ideas 24 which meet the requirements of the commercialisation company. The new product ideas are sourced from originators, for example product design agencies 26, individual inventors or entrepreneurs 28, brand owners 30 or those involved in corporate recovery 32. A product design agency 26 might have a new product idea which arose out of a design commission or other project, but was never exploited, so the agency may be looking for assistance in exploiting the product idea. An individual inventor or entrepreneur 28 might not have the skills, resources or experience to develop a new product idea, and may be looking for support in commercialisation. A brand owner 30 might have developed new products to a certain stage and then changed market focus, so that the product no longer falls within the range of products which they are looking to exploit. An insolvency practitioner involved in corporate recovery 32 may acquire intellectual property rights in a product through the winding up of a company, and may be looking to extract value from the intellectual property rights.

The filtering process may include the completion of questionnaire forms by the originator and checks by professional advisers such as patent attorneys or legal advisors. In the filtering process new product ideas are screened against a number of predetermined criteria selected by the commercialisation company. The criteria may include criteria relating to patentability, freedom-to-use searches, nature of competing products, cost of manufacture, potential profit, health and safety issues, size of market, type of market, requirements of known potential investors, due diligence in relation to ownership of intellectual property rights and any other suitable criteria as defined by the commercialisation company.

It should be noted that the commercialisation company may usually carry out the scouting for and filtering of product ideas 22 with no reference to a client or brand owner, and may only seek a brand owner interested in acquiring rights to the product idea later in the process, as described below. However, in an optional stage at the beginning of the process, as shown in block 20, a client, for example a brand owner, presents a strategic brief, to the commercialisation company. The brief may identify particular requirements of the client, for example a particular type of product which the client would like to bring to the market, an identified market need which the client would like to meet, or a particular technology which the client is unable to obtain internally or from other sources. For example a brand owner who develops pharmaceutical compounds may be looking for a new delivery technology. If a client is involved in providing a strategic brief, payment may be made by the client to the commercialisation company.

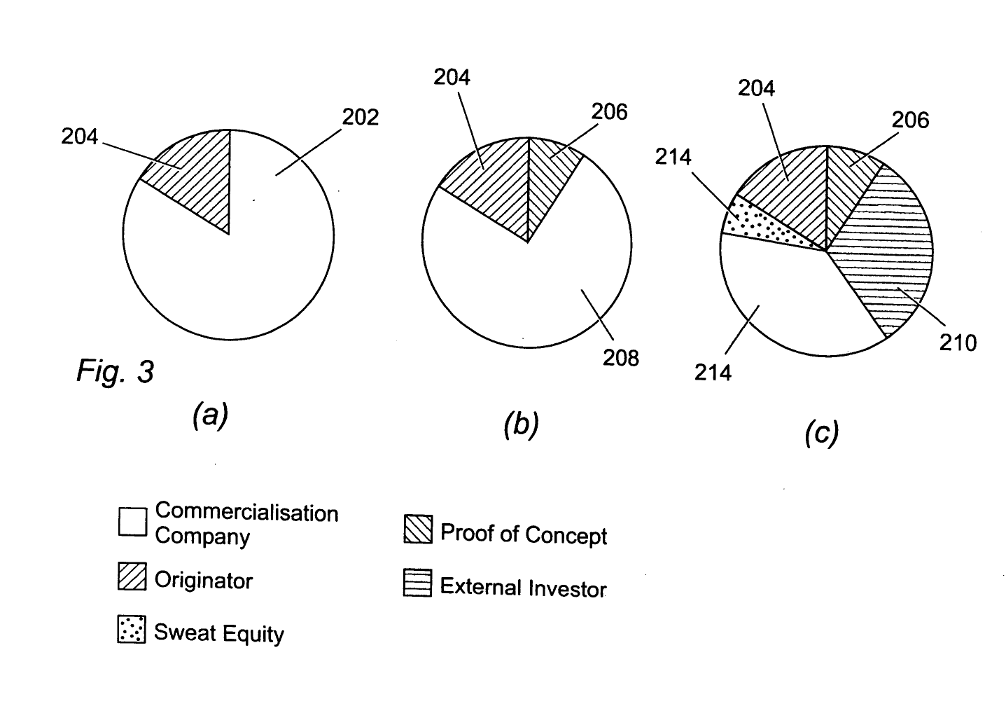

Once a filtered product idea has been identified, the intellectual property rights associated with the filtered product idea may be assigned to a new portfolio corporate identity or portfolio company 36 established by the commercialisation company, as shown in process block 34. The portfolio company is established for the primary purpose of developing the product idea and providing a return on investment made in developing the product. The originator 26, 28, 30, 32 assigns the intellectual property rights in the filtered product idea in exchange for a share in the value of the portfolio company. This is shown in FIG. 3(a), which shows the ownership of the portfolio company at its incorporation. The originator holds a minority share in the value, which may be protected against subsequent dilution, while the commercialisation company holds a majority share in the value in return for the investment to the portfolio company made by the commercialisation company, as shown in process block 38. Although not shown in FIG. 3(a), there is an opportunity for the originator to be granted a further share in the ownership of the portfolio company 36 in recognition of investment in developing the product idea before the assignment of rights in the product idea to the portfolio company 36. For example if the originator had invested a significant sum in patent protection and prototype manufacture, then the originator may be granted an increased share in the ownership. There is also an opportunity for a client or brand owner to invest in the portfolio company at this stage, as shown in process block 40.

If a client is involved in providing a client strategic brief 20, then the client may be involved in reviewing the filtered product idea in a further filtering stage, prior to deciding whether to continue with establishment of the portfolio company 36 in process block 34.

The formation of the portfolio company 36 and the assignment of the intellectual property rights associated with the filtered product idea are facilitated by standard documentation prepared by the commercialisation company. This enables the portfolio company to be set up easily and efficiently, while ensuring that the intellectual property rights are properly held by the portfolio company. The documentation can include clauses which govern exit strategies and what happens if the product development process reaches certain milestones.

Different classes of shares in the portfolio company 36 may be provided to facilitate control of the portfolio company 36 by the commercialisation company while allowing other parties, including the originator to share in ownership of the value in the portfolio company 36. For example the company documentation may establish “A” shares which carry voting rights and a share in the value of the business and “B” shares which carry a share in the value of the business but no voting rights. The originator may be granted “B” shares only, while the commercialisation company may hold “A” shares. The company documentation may determine that following an exit, for example sale of the portfolio company 36, “B” shares shall rank as equal to “A” shares and thus carry voting rights.

Since the commercialisation company has a controlling interest in the portfolio company, it can direct the next stage in the process, subjecting the filtered product idea to product development, shown in process block 42, using its skills and experience in product development.

Alternatively the commercialisation company, through the portfolio company, may further include granting a licence to the brand holder to carry out one or more product development tasks in relation to the filtered product idea. This may be done where the brand holder has specific skills and expertise in developing products of the type of the filtered product idea.

The product development tasks may include developing a product design based on the filtered product idea, manufacturing a prototype, market testing of the product design, consumer validation of the product design and pilot manufacture of the product design.

The success of the product development may be measured by market research response, consumer response or by achieving a predetermined volume of sales of products manufactured according to the product design. This success may be termed market acceptance. The product may be considered as validated. The commercialisation company may then make a validated product offer 44 to a client or brand owner. If a brand owner was involved in the early stages of the process, then the validated product offer would be made to that brand owner. The brand owner may purchase the portfolio company 36 and all rights to the product, as shown in process block 46.

If no brand owner was involved in the early stages of the process, then the validated product offer would be made to any brand owner identified by the commercialisation company as a potentially interested brand owner. The commercialisation company may develop skills and expertise in identifying which brand owners might be interested in exploiting which products, through bringing a number of portfolio companies into existence and through networking. Any suitable brand owner may then purchase the portfolio company and all rights to the product, as shown in process block 48.

The method of the invention is not limited to any particular timescales, but by way of example only product idea scouting and filtering 22 may take 3 months, while a portfolio company 36 may be established 5 months after receiving the client specific brief. Validated product offers 44 may be made 12 months after receiving the client specific brief, while sale of the portfolio company may be made 6 months later.

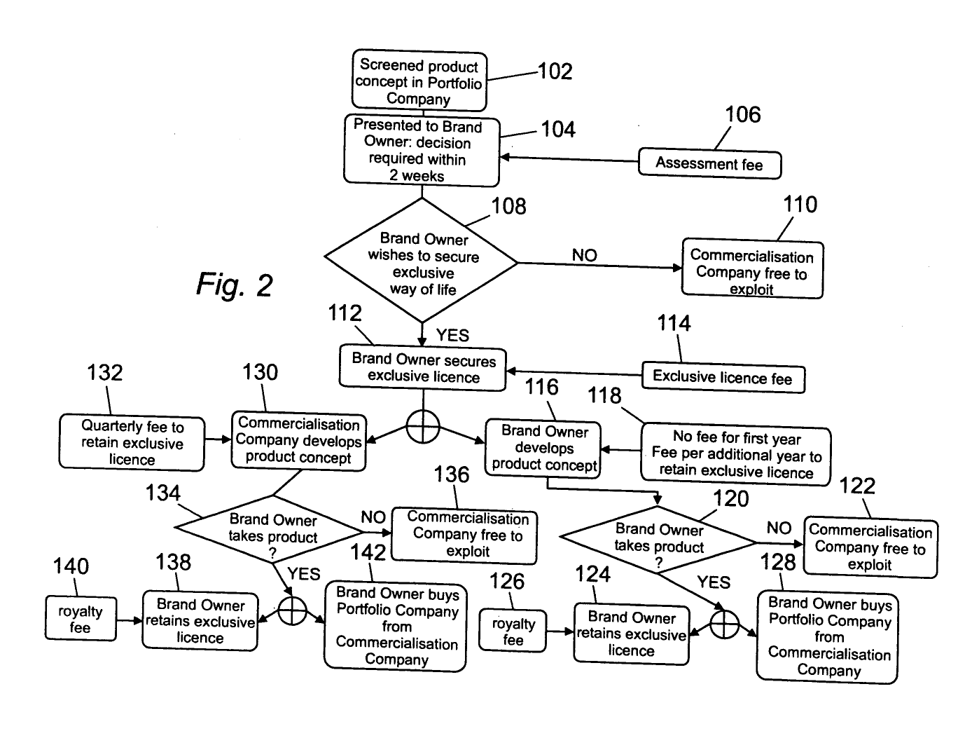

FIG. 2 is a flow-chart illustrating a possible procedure whereby a brand owner is given options to exploit a product idea developed according to one aspect of the present invention. The procedure corresponds to the stages shown in process blocks 42 and 46 in FIG. 1.

After rights in the screened product have been assigned to the portfolio company 36, as shown 20 in block 102, the product concept is presented, as shown in block 104, to a brand owner who pays an assessment fee to the commercialisation company, as shown in block 106. Typically the brand owner is given an exclusive option on the product for a limited time, typically 2 weeks or so. The brand owner must then decide whether he wishes to secure exclusive rights to the product concept, as shown in block 108. If he declines, then the commercialisation company is free to exploit the product concept itself, or to find another brand owner and start the process again, as shown in block 110. If he accepts, then the portfolio company grants the brand owner an exclusive licence, as shown in block 112, in return for an exclusive licence fee paid by the brand owner to the portfolio company, as shown in block 114.

At this stage product development can take one of two routes. According to a first route, the brand owner may choose to develop the product concept, as shown in block 116, in which case recurring license fees to retain the exclusive licence may be waived for a period, typically 12 months, as shown in block 118. Following completion of the product development phase, which may include any of the product development tasks referred to above, or any other activities which the brand owner considers appropriate, the brand owner must decide whether to acquire the rights to the product, as shown in block 120. If he declines, then the commercialisation company is free to exploit the product concept itself, or to find another brand owner and start the process again, as shown in block 122. If he accepts, then either the portfolio company grants the brand owner a long-term exclusive licence, as shown in block 124, in return for an exclusive licence fee paid by the brand owner to the portfolio company, as shown in block 126, or the brand owner buys the portfolio company from the commercialisation company, so that the commercialisation company, the originator and any other investors realise a return on their investment.

According to a second route, the commercialisation company may develop the product concept, as shown in block 130, during which time the brand owner continues to pay recurring license fees to retain the exclusive licence, as shown in block 132. Following completion of the product development phase, which may include any of the product development tasks referred to above, or any other activities which the brand owner or commercialisation company considers appropriate, the brand owner must decide whether to acquire the rights to the product, as shown in block 134. If he declines, then the commercialisation company is free to exploit the product concept itself, or to find another brand owner and start the process again, as shown in block 136. If he accepts, then either the portfolio company grants the brand owner a long-term exclusive licence, as shown in block 138, in return for an exclusive licence fee paid by the brand owner to the portfolio company, as shown in block 140, or the brand owner buys the portfolio company from the commercialisation company, so that the commercialisation company, the originator and any other investors realise a return on their investment.

Modifications to this process are possible. The product development can take place without any input from a brand owner, and the product can be developed to the stage of a validated product offer 44 by the commercialisation company alone. At this stage the product is offered to a suitable brand owner, who may be identified by the commercialisation company and who must decide whether to acquire the rights to the product, as shown in block 134. From this point on the process continues as described above with reference to FIG. 2.

It is to be understood that any actions described as being carried out by the commercialisation company may instead be carried out by the portfolio company directed by the commercialisation company.

FIG. 3 shows schematically how share ownership, that is ownership of the value, of a portfolio corporate entity according to a method of the invention may vary with time. When the company is established there may be two shareholders. FIG. 3(a) shows the shareholding position at set up of the portfolio company 36. The commercialisation company has the majority shareholding 202 and the originator 26, 28, 30, 32 has the minority shareholding 204. FIG. 3(b) shows the shareholding position during the product development stage, during which external investment may be obtained. “Proof of concept” funding may be available from public or commercial organisations in exchange for a share in the value of the business identified as a “proof of concept” shareholding. This may be in “A” or “B” shares as defined above.

The originator's equity may be protected against dilution, so the shareholding 208 of the commercialisation company may decrease in proportion terms.

FIG. 3(c) shows the shareholding position prior to disposal of the portfolio company to a brand owner. External investors, including the potential purchaser, may have provided investment during the product development phase in return for equity 210 in the portfolio company. If the originator provides active input to the product development phase, for example by working on the project, in return the originator can be given increased equity, referred to as “sweat” equity 212. Since the originator's original equity may be protected against dilution, the originator's shareholding increases, while the shareholding 214 of the commercialisation company may decrease in proportion terms.

The formation of the portfolio company 36 and the assignment of the intellectual property rights associated with the filtered product idea are facilitated by standard documentation prepared by the commercialisation company.

### Assignment Document

The assignment document which enables the assignment of intellectual property rights from the originator to the portfolio company ensures that all the appropriate intellectual property rights are assigned. It may define intellectual property rights as all patents, patent applications, rights to inventions, copyright and related rights (including without limitation rental right, right to authorise or prohibit lending and database right subsisting now or created at any time hereafter), know-how, trade marks and service marks, trade names and domain names, rights in get-up, rights to goodwill or to sue for passing off or unfair competition, rights in designs, rights in computer software and any other intellectual property rights, in each case whether registered or unregistered and including all applications (or rights to apply for), and renewals or extensions of, such rights and all similar or equivalent rights or forms of protection which subsist or will subsist now or in the future in any part of the world relating to the product or its design, manufacture or sale. It may refer to intellectual property rights set out in a schedule.

The assignment document may include an undertaking on the part of the originator to do all such acts and things and execute all such documents as may reasonably be necessary or desirable to secure the vesting in the portfolio company of all rights assigned to the portfolio company hereunder including to enable it to be registered on the relevant register as the owner of any registered intellectual property rights in any country.

The assignment document may require warranties on the part of the originator.

The assignment document may include an undertaking on the part of the originator to assign future improvements in the product.

The assignment document may include an option for the originator to reacquire the intellectual property rights in the event that an Exit, as defined in a company document, has not taken place within a period of a number of years, typically 5 years, of the date of the assignment for a consideration to be agreed or determined by an independent party.

A plurality of assignment documents may be used instead of a single assignment document in circumstances where more than one party holds rights in the product idea.

### Company Documents

One or more company documents may be prepared to govern the establishment and running of the portfolio company.

The company documents may regulate the class of shares or stocks in the portfolio company, the rights accorded to different classes of shares or stocks, the issue of new shares, the requirements at Exit, i.e. the disposal, sale or winding up of the portfolio company, the transfer of shares, procedures in the event of an offer to purchase shares by a third party, the appointment of directors or company officers, the holding of meetings and any other company activities.

The company documents may ensure that the commercialisation company has a controlling interest in the portfolio company for the life of the portfolio company or until the portfolio company is sold to a third party.

The method of the invention provides a model for developing innovative products which offers a number of significant advantages for originators and brand owners, as well as other parties such as external investors.

The method of the invention offers an ownership model that is transparent, provides the commercialisation company with control over the development and funding process, sets clear expectations with the originators at the point of engagement, protects the future value to the originator of the product concept, incentives and rewards contributors to the development process, and provides the ability to cleanly dispose of the product concept while maintaining separation from other products under development and the parent group

The method of the invention offers a product scouting model that may actively seek needs from brand owners, and that manages the introduction and subsequent development of product concepts that meet their needs.

The method of the invention offers a screening process to evaluate new concepts.

The method of the invention makes possible a document trail providing a history of the product from initial contact through to final exit. This is of great advantage for due diligence purposes.

The method of the invention may make use of a set of legal documents which govern the formation of the portfolio company, the assignment of intellectual property rights and the control the equity distribution in a way that mirrors the business model.

The method of the invention offers an assignment and ownership model which reverses the normal venture capital model, by guaranteeing the originator a minimum share of the future value which is not diluted until certain defined exit points have been achieved.

The method of the invention offers a valuation mechanism that is capable of recognising additional effort by the originator, either before or after the involvement of the commercialisation company, in the form of “sweat” equity.

The method of the invention may focus on brand owners and design agencies as originators providing primary source of product concepts. Product concepts from such originators may typically be more developed than those from individual contributors or inventors.

The method of the invention offers a scouting model that presents product concepts to brand owners only after they have been screened and protected in portfolio companies, and that may not require payment of any retainer.

Many modifications and other embodiments of the invention will be apparent to one skilled in the art to which this invention pertains having the benefit of the teachings presented in the foregoing descriptions and the associated drawings. It is to be understood that the invention is not limited to the specific embodiments disclosed and that modifications and other embodiments are intended to be included within the scope of the appended claims. Although specific terms are employed herein, they are used in a generic and descriptive sense only and not for purpose of limitation. The term “corporate entity” may include a company, a corporation, a limited liability partnership or any other legal entity which can be created for the purpose of trading. The term “product idea” may include any innovation, such as a method, process, apparatus, system. The term “brand owner” may include any corporate or legal entity or individual who is interested in acquiring rights in a product idea. The terms “share capital” and “shareholding” may include any share in the value of a corporate entity, such as stocks or bonds.

We claim:

1. A method of developing a product idea through establishment of a corporate entity, the method comprising:
screening one or more new product ideas against a number of predetermined criteria to identify a filtered product idea which meets the predetermined criteria,
establishing a portfolio corporate entity having share capital,
assigning intellectual property rights in the filtered product idea to the portfolio corporate entity,
controlling the portfolio corporate entity while the filtered product idea is subject to product development.

2. A method according to claim 1, in which the method further includes bringing the filtered product idea to market.

3. A method according to claim 1, in which the method further includes granting rights in the filtered product idea to a brand owner.

4. A method according to claim 1, in which the method further includes carrying out one or more product development tasks in relation to the filtered product idea.

5. A method according to claim 3, in which the method further includes granting a licence to the brand owner to carry out one or more product development tasks in relation to the filtered product idea.

6. A method according to claim 3, in which the method further includes granting a share in the value of the portfolio corporate entity to the brand owner.

7. A method according to claim 3, in which the method further includes licensing intellectual property rights in the filtered product idea from the portfolio corporate entity to the brand owner.

8. A method according to claim 1, in which the method further includes purchasing share capital in the portfolio corporate entity sufficient to take a controlling interest in the portfolio corporate entity.

9. A method according to claim 1, in which the assigning step comprises purchasing the intellectual property rights from a product originator in return for a consideration comprising a share in the value of the portfolio corporate entity.

10. A method according to claim 9, in which the product originator is a first owner of the intellectual property rights in the filtered product idea.

11. A method according to claim 9, in which the product originator acquires the intellectual property rights in the filtered product idea from a first owner of the intellectual property rights in the filtered product idea.

12. A method according to claim 3, including the further step of identifying a strategic brief from the brand owner and including criteria derived from the strategic brief in the predetermined criteria.

13. A method according to claim 11, including after the screening step the further steps of presenting a filtered product idea to the brand owner and offering an exclusive licence under the screened product to the brand owner.

14. A method according to claim 5, including the further step of receiving a licensing fee from the brand owner during the carrying out one or more product development tasks in relation to the filtered product idea.

15. A method according to claim 4, wherein the product development tasks include at least one of developing a product design based on the filtered product idea, market testing of the product design, consumer validation of the product design and pilot manufacture of the product design.
